(19) United States
(12) Patent Application Publication
(10) Pub. No.: US 2023/0057305 A1
(43) Pub. Date: Feb. 23, 2023

(54) APPARATUS AND METHOD FOR UNIFORM AIR GAP IN THIN FILM MAGNETIC CORES

(71) Applicant: Atlas Magnetics, Reno, NV (US)

(72) Inventors: John Othniel McDonald, Reno, NV (US); Osman Ersed Akcasu, Cardiff-by-the-Sea, CA (US)

(21) Appl. No.: 17/893,108

(22) Filed: Aug. 22, 2022

Related U.S. Application Data
(60) Provisional application No. 63/235,714, filed on Aug. 21, 2021.

(51) Int. Cl. H01F 27/24; H01F 1/147; H01F 41/02

(52) U.S. Cl. CPC H01F 27/24; H01F 1/14708; H01F 41/0206

(57) ABSTRACT

A complex-shaped air gap for electrical components utilizing magnetically permeable material. The air is enabled to thermally distribute heat through a magnetic core and thus reduce issues relating to heat localization. The air gap shape is maximized for length, and in the preferred embodiment is a spiral shape. The preferred embodiment is built by a lithography process, without cutting, to enable the thin spiraling shape.

### BACKGROUND

The general field of the present invention relates to the use of magnetic flux in electrical circuits and components such as inductors and transformers. More specifically, the field of the present invention relates to air gaps in such systems.

Air gaps, as the name implies, are gaps in a magnetic material that otherwise forms a loop around a wire coil. Air gaps are introduced into a magnetic core primarily to extend the maximum Bsat, lower the process variability of a core, and to tune the total inductance of the electronic component. However, air gaps due to their much higher reluctance as compared to the rest of the core contain most of the magnetic energy during operation and thus create inefficient hotspots. An air gap can be filled with any material that has a much lower permeability that main magnetic core material but usually it is plastic, air, or a similar insulator with a relative permeability (μᵣ) of near 1.

Although the concept of introducing an air gap into a magnetic circuit is simple, air gaps in most transformers or inductors have been limited to one or two straight cuts often for cost or process capability reasons such as the use of saws and molds. In more advanced, devices these air gaps have been cut diagonally or multiple cuts made to spread the effects of the air gaps and their high associated energy density across more of the core.

In recent powdered soft magnetic cores, each magnetic particle is covered in an oxide that performance the same function of an air gap and thus the air gap effect is all but perfectly distributed throughout the core which also results in very uniform heating and the maximum elimination of hotspots. However, in this case the oxide layer is difficult to precisely adjust and, in many cases, limits the overall inductance of the device at relatively low maximum inductance. Finally, these powdered cores are not process compatible due to high temperatures and pressures with integration onto a silicon wafer surface or built directly in a semiconductor plastic epoxy package.

New metallic laminated thin film cores are now moving from the research lab to production where each layer is electroplated, insulated, and the process repeated until many layers have been formed to complete the magnetic. In the process of layering this core, the coil, usually electrodeposited copper is built around the core to form the inductor or transformer.

As the electroplated metallic cores are improved there exists a need to introduce air gaps in these cores in a manner like the soft magnetic powder cores which yields a near uniform air gap affect across the entire core so no one region is unduly stressed. Further, there exists a need to have better engineering control over these air gaps to improve the total inductance of the device or increase the effective Bsat when needed.

The following United States Patents and Published Patent Applications are incorporated by reference in full:

US 20220068542 A1 Automotive variable voltage converter with inductor having diagonal air gap invented by Baoming Ge, Lihua Chen, and Serdar Hakki Yonak

U.S. Pat. No. 5,609,946 A High frequency, high density, low profile, magnetic circuit components invented by Korman Charles S , Jacobs Israel S , Mallick John A , and Roshen Waseem A

US 2004/0158801 A1 Method of manufacturing an inductor invented by Leisten Joe, Lees Brian, and Dodds Stuart

US 2011/0199174 A1 Inductor Core Shaping Near an Air Gap invented by Carsten Bruce W

U.S. Pat. No. 4,047,138 A Power inductor and transformer with low acoustic noise air gap invented by Steigerwald Robert L

U.S. Pat. No. 7,573,362 B2 High current, multiple air gap, conduction cooled, stacked lamination inductor invented by Clifford G. Thiel, Darin Driessen, Debabrata Pal, and Frank Feng

The following international patent application is incorporated by reference in full:

WO 2012079826 A1 Thin film inductor with integrated gaps Herget Philipp, Fontana Jr Robert Edward, Webb Bucknell, and Gallagher William

The following research is incorporated by reference in full:

Guo, Xuan, Li Ran, and Peter Tavner. “Lessening gap loss concentration problems in nanocrystalline cores by alloy gap replacement.” The Journal of Engineering 2022.4 (2022): 411-421.

Liao, Hsuan, and Jiann-Fuh Chen. “Design process of high-frequency inductor with multiple aft gaps in the dimensional limitation.” The Journal of Engineering 2022.1 (2022): 16-33.

“Engineering Electromagnetic Fields and Waves,” Carl T. A. Johnk, John Willey & Sons, Copyright 1975, ISBN 0-471-44289-5.

“Elements of Electromagnetics,” Matthew N.O. Sadiku, Oxford University Press, Copyright 2001 Third Edition, 2001, ISBN 0-19-513477-X.

“Power Electronics,” N. Mohan, Tore M. Undeland and William P. Robbins, Third Edition, Copyright 2003, John Willey and Sons, Inc., ISBN 9780-471-22693-2.

### BRIEF SUMMARY OF THE INVENTION

The present invention comprises specially designed air gaps for electroplated magnetic cores for use in electrical components, such as inductors and transformers. More specifically electroplated magnetic cores that are manufactured at temperatures and pressures compatible with silicon wafers or semiconductor epoxy plastic.

In general, the ability to make very novel air gap structures in these high-layered magnetic cores exists because the electroplated metallic cores are not limited to molding specifications as ferrite and soft metallic cores or straight-line cuts by a saw or laser as many power transformers made from silicon steel. Further, the electroplated metallic cores can have a different air gap pattern on each layer for no additional cost further expanding the design possibilities.

The perfect air gap in terms of a uniform distribution over the entire core to avoid hotspots is similar what the soft metallic cores can achieve with the air gap surrounding each magnetic particle. To approximate this uniform effect: one or more air gaps are patterned during the electrodeposition of the magnetic layers that gradually spiral from the center of the core to the outer edge. This near 2D “spiral” air gap can easily be adjusted in terms of the degrees it spirals until reaching the outer edge, as shown in FIG. 1. The uniformity and width of the air gaps 101 through magnetic core 100 depend on the air gap 101 to magnetic metal ratio desired by the application.

To further spread the uniformity of the air gaps across the laminations, each layer is intentionally rotated or adjusted in some manner with respect to the prior layer to maximally distribute the air gaps throughout the entire core, as shown in a top view of the magnetic core in FIG. 2. In FIG. 2 the magnetic core with air gaps 101 of FIG. 1 serves as a first layer in FIG. 2. This first layer with air gaps 101 is stacked, by means of electroplating, with a second layer with air gaps 211. Air gaps 211, in this example, are spiral air gaps 211; however, as the layer was created on a previous layer, the position of air gaps of the new layer has been adjusted to increase the distribution of gaps throughout the core.

FIG. 3 shows a see-through view of a magnetic core with four layers stacked on top of each other to form stack 300, where the air gaps 302 remain visible. Here it can be seen that the air gaps 302 of stack 301 are all offset from layer to layer.

However, while it is usually preferred to have a uniform distribution of air gap throughout the core, there are some cases where a varying density of air gap may be desired. For example, having a lower density of air gap in the center of the core, which is far from a cooler ambient environment, may be desired, and so the “spirals” can be adjusted to pass quickly through the center of the core and extend near the inner and outer surfaces.

“Spiral” air gaps may approximate a circle but can also be mapped to all the common inductor, coupled inductor, transformer shapes including solenoid, toroid, and spiral or a hybrid of those shapes as seen in FIG. 4. In FIG. 4 a hybrid magnetic core shape 400 receives spiraling air gaps 402 which are not circular, but align with the shape of the magnetic core 401. The term spiral, for the purposes of this application, also includes piecewise linear air gap approximations of curving spirals.

In general, the air gap is designed in such a manner to enable a much longer gap without increasing the width of the gap as compared to a traditional straight line air gap. The longer air gap spreads the air gap magnetic energy storage over a much broader area, which reduces the magnetic power density in the air gap region, resulting in improved thermal performance.

The longer “spiral” air gap also allows for a wider air gap to achieve the same

Bsat performance compared to a straight-line air gap. A wider air gap is often advantageous as the manufacturing tolerances are easier to reliably achieve as well as creating a larger fringing effect which keeps total inductance higher. Conversely, using the same minimum width air gap but a much longer one as compared to a straight-line air gap has the effect of creating an air gap below the minimum manufacturing tolerances, again as compared to a straight-line air gap.

In demonstrative embodiments of the present invention, the magnetic material is under thirty-five microns (35 μm) thick, and the air gap is one hundred microns (200 μm) or less in width (some examples being 80 microns, 40 microns, 20 microns, and 10 microns, although any number under 200 is acceptable in this preferred embodiment). The gap, however, is very long, following the length of the magnetic material and, in some embodiments of the present invention, extending entirely along the circumference of the material multiple times.

The air gaps may vary in width from the inner edge to the outer edge to achieve the desired energy density in operation, or the number of uniform width air gaps and locations can be varied to achieve the same effect. By increasing the length of the air gap(s) and balancing it with the width of the air gap(s), a greater range of reluctance values can be achieved by using the gap while reducing the negative effects of localized heat build-up.

The air gap's physical parameters in this present invention are determined by many factors, and these factors include total inductance, effective Bsat desired, manufacturing tolerances, uniformity of thermal performance, and the distance not only across the air gap on the same layer but the distance to the adjacent layers.

However, the most common optimized shape of the air gap is wherein an air gap pathway is formed by the first boundary edge and the second boundary edge follows an edge boundary of the magnetic core and spirals into the opposite edge boundary of the magnetic core. This creates a spiraling shape that spirals inwards or outwards, although the spiral does not have to reach the opposite edge of the magnetic core (for instance, the shape of the air gap may change at the end of the spiral).

In some manufacturing systems, air gap shapes are limited to 45- or 90-degree angles. The present invention also considers and includes piecewise approximations of the shapes mentioned limited by manufacturing systems often used in the semiconductor industry when the term for the shape is used.

### BRIEF DESCRIPTION OF THE FIGURES

FIG. 1 shows the present invention's magnetic core layer with a two-dimensional spiral air gap.

FIG. 2 shows a see-through perspective of two layers matching the layer of FIG. 1 built on top of each other, but where one layer has been rotated from the other to offset the air gaps.

FIG. 3 shows a see-through perspective of a magnetic core with four air-gapped layers where the air gaps are visible and uniformly distributed.

FIG. 5 shows an air gap on the edge of a magnetic core coming to an angled point.

FIG. 6 shows an air gap on the edge of a magnetic core coming to a blunt point.

FIG. 7 shows an inductor core simulation with a spiral air gap mapped out with a heat distribution overlay from the simulation.

FIG. 8 shows an inductor core simulation with two spiral air gap pathways.

FIG. 9 shows an inductor core simulation that has two spiral air gap pathways out with heat distribution from the simulation overlayed.

FIG. 10 shows a demonstrative air gap with magnetic flux lines, including the fringing lines.

FIG. 11 shows a magnetic flux line jumping from one layer of a magnetic core to another layer of a magnetic core.

FIG. 12 shows a magnetic core having an initial cross-section of a gap cut in its outer edge.

FIG. 13 shows a core with a spiral gap where the spiral gap is comprised of a combination of curved and straight path lines.

FIG. 14 shows the magnetic core of FIG. 12 where the cross-sectional cut has been mapped along a spiral path.

FIG. 15 shows the magnetic core of FIG. 14 now having an additional air gap.

FIG. 16 shows the magnetic core of FIG. 15 now having two additional air gaps.

FIG. 17 shows a magnetic core having a three-prong optimized pathway for heat distribution.

FIG. 18 shows that layers of a laminated core can have different air gap widths.

FIG. 19 shows layers of a laminated core, each layer having an offset air gap.

FIG. 20 shows a laminated core with a textured surface with a layer demonstrating an air gap path.

FIG. 21 shows a laminated core with insulative deposits formed by Chemical Combustive Vapor Deposition (CCVD) along the boundary edges of the air gap.

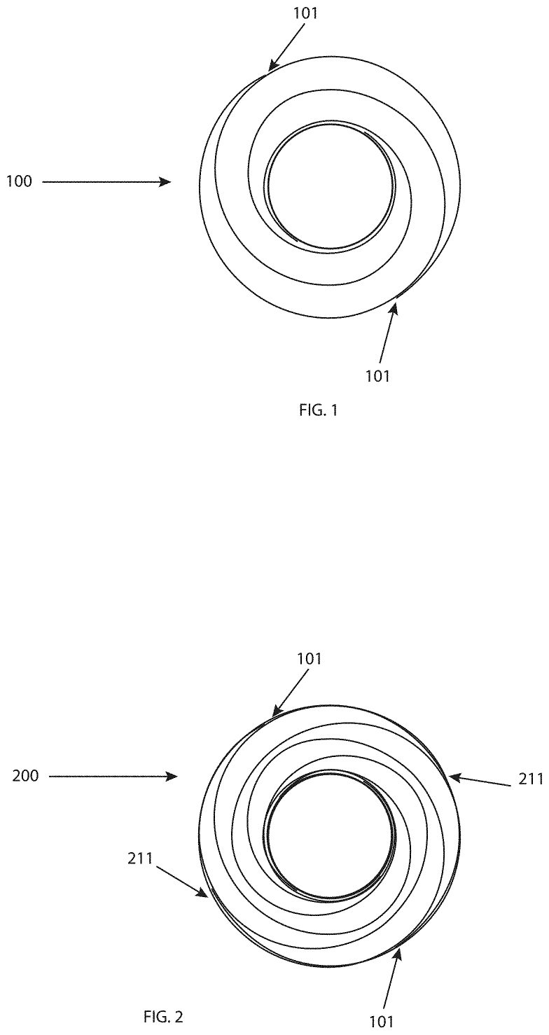

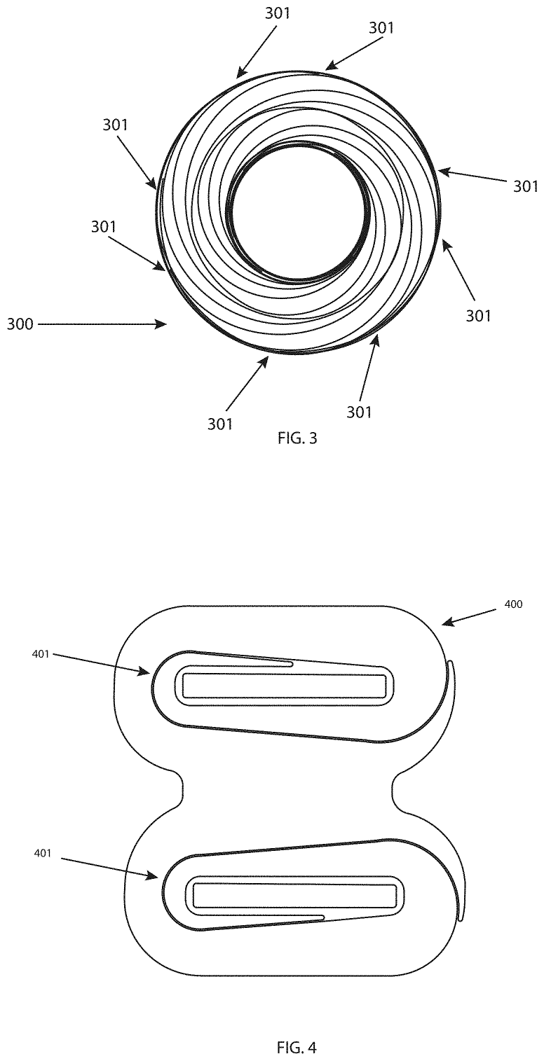

### DETAILED DESCRIPTION OF THE INVENTION

The present invention comprises one or more optimized air gaps for electroplated magnetic cores for integrated inductors and transformers. The specific application purpose is to generate these magnetic components in a process that is temperature and pressure compatible with silicon wafer-based circuits and or semiconductor epoxy packaging. Electroplated magnetic cores are made of NiFe 80/20, NiFe 78/22, NiFe 45/55, CoNiFe or various alloys of cobalt, nickel, or iron that meet these temperature and pressure requirements. These metallic magnetic cores are usually highly layered because metal alloys made of magnetic metals such as Ni, Fe, and Co generate high eddy currents due to their low resistance, especially at higher frequencies >100 kHz. Thus, these cores must usually be laminated to increase the total amount of metal and are thus separated by electrical insulation, which cuts the eddy currents and results in core losses.

An air gap is formed by creating a small separation from a first boundary edge to a second boundary edge in a magnetic core (core). The magnetic flux flowing in the core is then forced to cross this air gap boundary, and thus, the air-gapped magnetic core properties become a combination of the air gap and the remaining magnetic core. The air gap volume is optimized considering the desired higher effective Bsat, total inductance, and uniformity of the new thermal profile created by the introduction of the air gap(s). The air gap in the embodiment of this invention is filled with ABF “Ajinomoto Build up Film,” which is an epoxy impregnated with 1-5 μm glass beads that have a permeability very close to air. However, the air gap may be filled with other materials, including permanent dry film, other epoxies, various oxides, or air.

The air gap is introduced to lower the overall permeability of the magnetic core and thus increase the maximum current allowed in the device by increasing the associated current-induced maximum magnetic saturation point or Bsat and in doing so, it also lowers the variability of the inductance, which often simplifies the driving circuits. But with the introduction of the air gap, thermal hotspots during operation may appear centered around these air gaps as the air gaps have a higher magnetic field during circuit operation due to their high reluctance as compared to the rest of the magnetic core.

The first goal of this invention is to create a uniform distribution of air gaps within a highly layered electroplated metallic magnetic core. A uniform distribution of air gaps is accomplished for a single layer by creating one or more air gap “spirals,” which start at the first inner boundary edge and slowly spiral to the outer boundary edge maximizing the air gap length up to the point at which the necessary inductance does not allow the removal of additional magnetic material. A uniform distribution of air gaps for multiple layers is accomplished by creating the same spiral as on a single layer, but then offsetting the next layer by a percentage or angle such that the air gaps are not aligned in adjacent layers but are instead and uniformly spaced in all dimensions: X, Y, and Z.

The spiraling effect can be around a square or rectangular coil and need not be perfectly circular as in the case of solenoids. The spiraling effect can be around one or more inductors as in the case of coupled inductors or transformers.

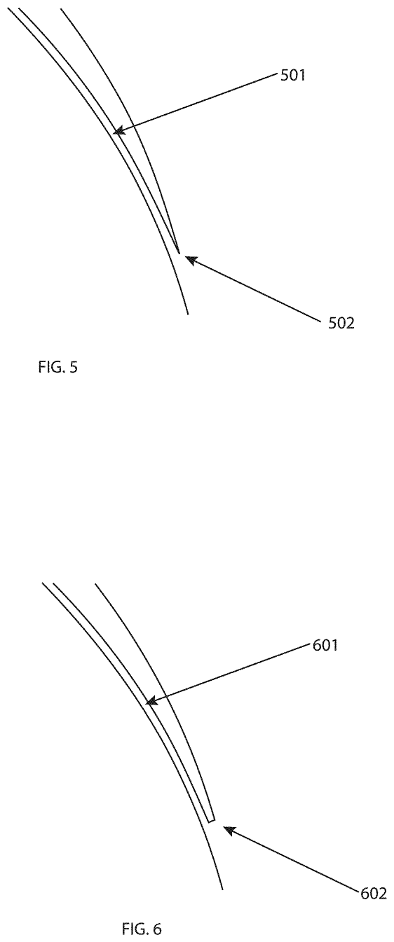

The spiraling air gap often naturally ends in a sharp point as shown in FIG. 5, where air gap 501 ends in a point 502. Sharp points in electroplating are known to be preferentially plated resulting in thicker deposits which may result in manufacturing yield issues due to out-of-spec magnetic layer thickness. To reduce the effect of preferential electroplating at the ends of the spiraling air gap, these ends may be brought to an abrupt end—being bluntly rounded as physical means to control this effect as shown in FIG. 6, where air gap 601 ends in a blunted point 602. In addition, leveling agents or pulse plating are process methods often used to achieve a more consistent thickness on sharp electroplated edges.

Some EDA “Electronic Design Automation” tools often used to layout devices on silicon or in advance packaging are limited to 45- to 90-degree corners. Thus, one embodiment of this invention covers piece-wise linear approximations of the spiraling air gaps.

While the first goal of this invention was to create a uniform distribution of air gaps in all dimensions of the magnetic core with the assumption that this yields a uniform thermal profile during operation. However, this assumption may not always be true, for example one such case, thicker cores have greater heat retention inside the core as compared to core surfaces in contact with air or other materials surrounding the inductor. This case may call for a lower air gap density close to the center of the core as determined in all three dimensions X, Y, and Z in order to reduce heat generation inside the core, thus achieving a more uniform thermal profile. In another case, the magnetic material of a toroid inductor will experience a higher magnetic flux near the inner ring as compared to magnetic material near the outer ring. In this case, a wider air gap(s) near the center that gradually narrows as it spirals outward may yield a constant reluctance regardless of the distance from the inner core resulting in a more uniform thermal profile.

Following are examples of multi-layered rectangular outline geometry magnetic cores with programmable air gaps also mapped to their circular equivalents. The structures can be simulated with full-wave simulators like HFSS or COMSOL. One such simulated structure with a spiral pathway is shown in FIG. 4. Where there are single spiral air gaps 401 on each side of core 400.

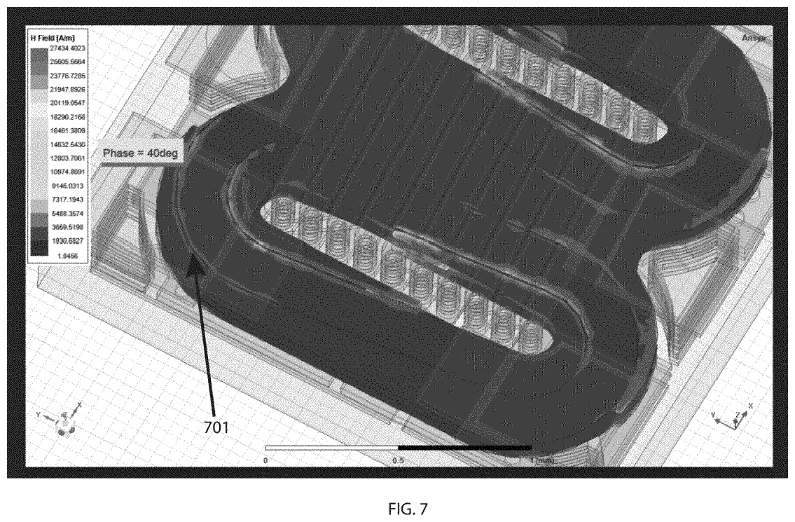

The thermal distribution results for the core 400 shown in FIG. 4 are presented in FIG. 7. Where the lighter regions around the air gap 701 show where heat would be distributed.

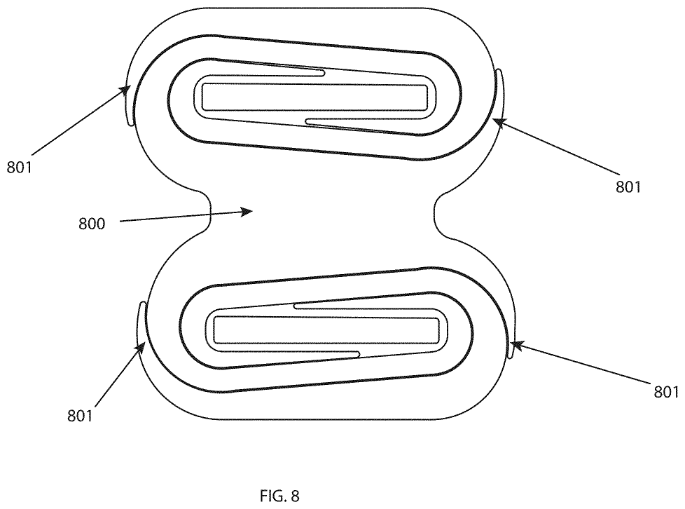

From these results, we see that an air gap mapped to a spiral inductor core dissipates heat along the length of the core instead of localizing the heat as a traditional air gap would. Cores are not limited to a single air gap; multiple air gaps can provide benefits, as shown in FIG. 8, which shows an inductor core having dual air gaps meaning two spiral air gaps 801 per side of core 800.

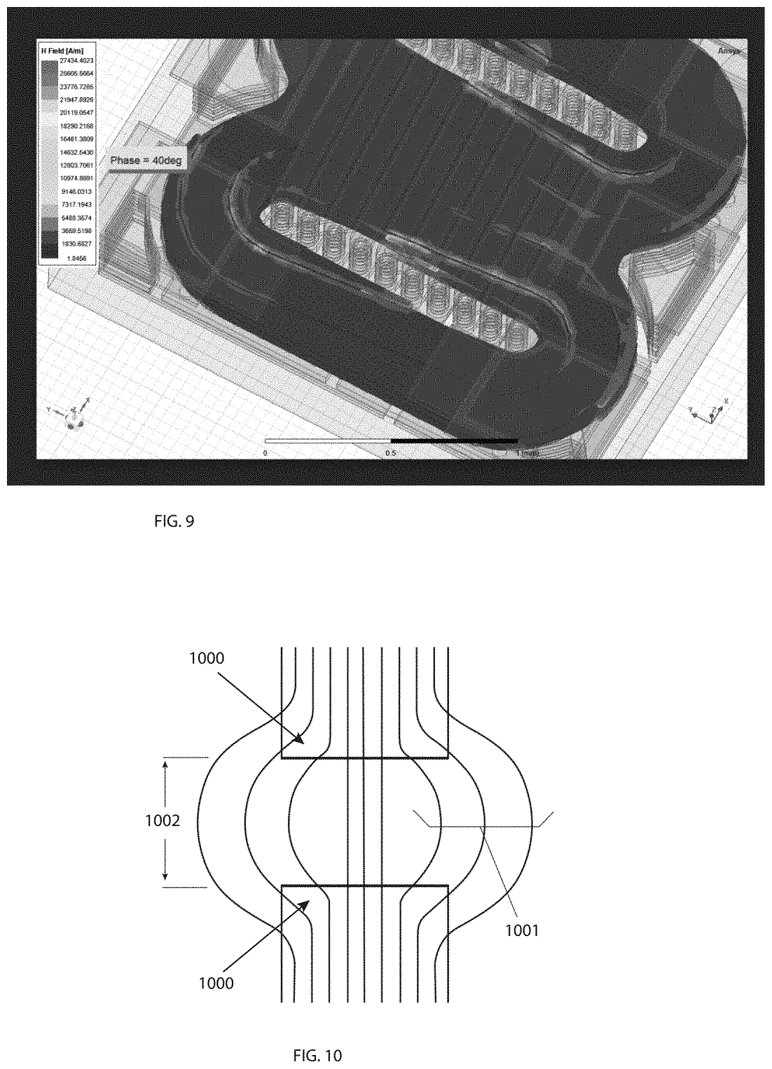

FIG. 9 shows a heat map simulation of the dual gapped inductor core, and it can be seen that this further distributes the heat when compared to a single gapped core.

As it can be seen from FIG. 8, and as noted above, the gaps can be mapped out along lengthwise pathways given a mapping function. Mapping the pathway of the air gap introduces several innovations and abilities into the air gap space.

Each air gap has an associated magnetic flux fringing field as shown in FIG. 10. where fringe 1101 is that which escapes around the edge of the core 1000 in gap 1002. Fringing effects are substantial in thin film magnetic cores as compared to much thicker cores where a higher percentage of the flux flows directly across the gap.

Fringe acts as a parallel reluctor with the other magnetic flux lines of the air gap (the lines that are passing straight through the air gap) so that fringe decreases the reluctance of the air gap and increases inductance. The fringe effect can be used to offset the reluctance caused by a gap. This increase may be significant, and for a rectangular area, which is calculated by

$${L}^{′} = L ( 1 + p ) where p = g \frac{a + b}{a b} \qquad ( 1 )$$

where a and b are sides of the rectangle area, g is the gap length, and L′ is the self-inductance. We can see that increasing the length of the gap has a multiplicative effect on inductance. Therefore, we can increase the self-inductance by increasing the gap length. The fringe effect makes this possible. Or in other words, a longer wide air gap can be inductively equivalent to a short narrow air gap. Therefore if manufacturing tolerances require a minimum width for an air gap that is still too wide for the application, then simply making the air gap longer has the same effect.

The fringing effect is not limited to a single layer as often the magnetic flux path of least reluctance when an air gap is encountered goes through an adjacent layer as shown below. Relatively simple math is all that is required to analyze the impact of one straight line air gap fringing field in isolation. However, adding curved air gaps in highly layer structures greatly increases the complexity of the calculations to the point where most analysis is conducted by a finite element analysis software. However, some general conclusions can be made with respect to fringing in effects in highly layered magnetic structures: the fringing effect is limited by both the distance of the air gap within the same layer and by the air gap that is naturally formed between adjacent layers with the shortest air gap dominating because it has the lowest reluctance. For most magnetic cores, superior performance is achieved by containing the majority of the fringing effect to the same core layer which implies the same layer air gap being shorter as compared to the adjacent layer air gap. However, as the adjacent air gap layer is often shorter than the calculated same layer air gap necessary for a higher effect Bsat, multiple same layer air gaps are used with a minimum spacing below that of the adjacent air gap.

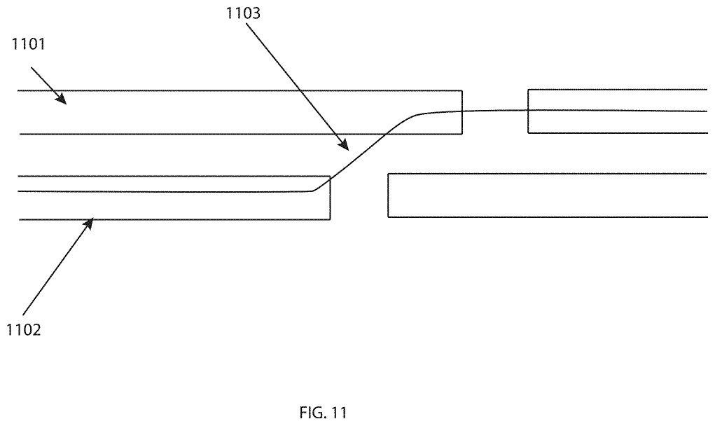

Flux lines jumping layers can be seen in FIG. 11 where a flux line 1103 jumps from a first layer 1101 to a second layer 1102.

Increasing gap length also has thermal benefits for the system. A gap is much more resistive to magnetic flux than the magnetically permeable core and contains most of the energy at any given time. As the current alternates, it generates heat in the gap and surrounding area. By increasing the area, the concentration of heat build-up is reduced, which improves the longevity and performance of the component as well as allows the component to be downsized.

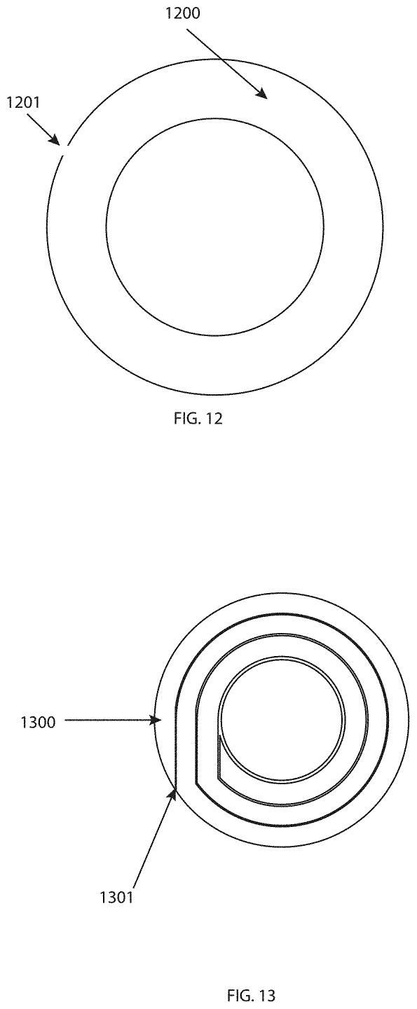

To increase gap length and area, we can take a thin air gap cross-section cut, and a demonstrative cross-section is shown in FIG. 12.

This cross-section 1301 in core 1300 is then mapped out to form a pathway. A pathway is defined by the pulling of the cross-section along a path in a core. The particular pathway may depend on the practical limitations of implementing an air gap in the material. A spiral shape will be used here as a demonstrative example of a pathway. In most cases, a spiral shape will be possible to manufacture and provides a strong optimization for a core. A spiral also allows the small-cross section of the magnetic core to present a full air gap across the core so that all magnetic flux lines must cross an air gap. (However, a full air gap is not necessitated.) A spiral air gap is formed when the first boundary edge and the second boundary edge of the air gap start following along an outer boundary of the magnetic core and spirals tighter into the inner boundary of the magnetic core. A spiral need not be a single continuously curving line but may include straight portions connected at angles to each other; a demonstrative example is shown in FIG. 13. Here, spiral 1301 initiates and repeats a linear section while traveling through core 1300.

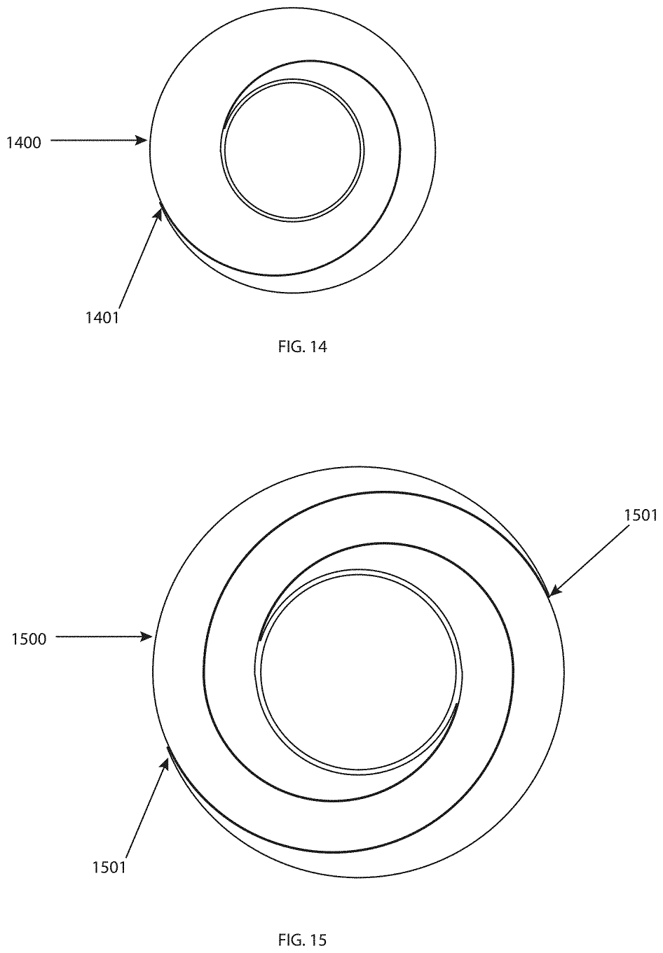

The cross-section cut of FIG. 12 has been mapped along a spiral pathway 1401 of core 1400 in FIG. 14.

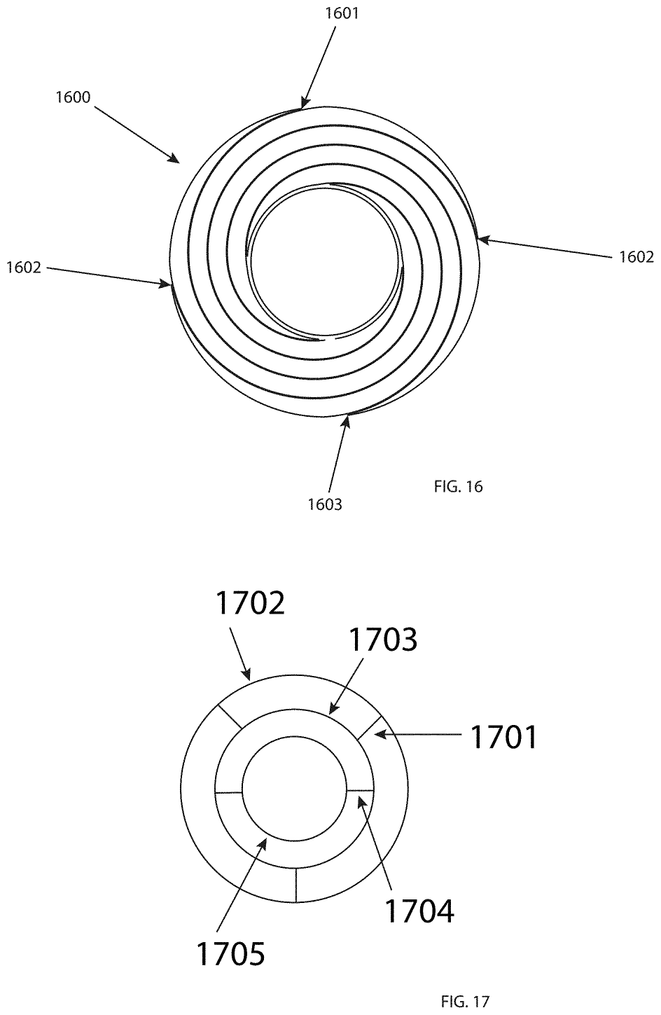

Additional air gaps can be added to the core as FIG. 15 and FIG. 16 shows a demonstrative example each.

In FIG. 15, there are three spiral area gaps 1501 winding into core 1500.

In FIG. 16, there are five spiral air gaps 1601 winding into core 1600. As more and more air gaps are added to a core, the precision of which air gaps can be made becomes more and more important.

A spiral is an optimal shape for magnetic flux distribution, as it allows the magnetic flux lines to be directed into the center. One way this occurs is if the width of the spiral air gap decreases as it gets closer to the center of the spiral. The greater width at the outer edges of the spiral creates more reluctance at the outer edges of the core. As the gap decreases in width, the reluctance it provides decreases as well. Therefore, the core will have an increasing reluctance from its inner edges to its outer edges. This change in reluctance can be tuned to offset the skin effect so that when the flux is in the core, it spreads out through the core. The spread is directed by the differing reluctance values of the core. Many possible pathways beyond spiral pathways can direct flux inwards and can be generated by forming an appropriate mapping function. This optimizes the magnetic core for magnetic flux distribution.

An air gap optimized specifically to spread the magnetic flux may appear different from an air gap optimized for thermal distribution. For instance, heat distribution aims to prevent localized heat build-up. To achieve this, heat is to be spread evenly throughout the core. In FIG. 17, a demonstrative pathway is shown.

This pathway has three perpendicular branches 1701 of the air gap, one in each outer third of core 1700, reaching the out edge 1702 of core 1700. These three air gap branches 1701 run from the outer edge of the core to the midpoint of the core arm material, where they meet with a mid-line air gap 1703 making a complete circle along the midline of the core. From this circle 3203, two air gaps 1704 branch out and reach the inner edge 1705 of the core. The midline gap helps distribute heat throughout and to the edges of the core. This pattern also demonstrates the potential variety of air gap pathways that can be designed by optimizing according to the method described above.

Air gaps can be made to balance thermal distribution with flux distribution. Further, these factors can be balanced with practical manufacturing factors such as cost and shaping precision. The gap of an air gap may be filled with alternate gap material, including alloys, as current industry research at large pursues that avenue. The boundary edges of an air gap define the pathway of the air gap. These boundary edges are the boundary edges of a cross-section of the pathway expanded and mapped according to the desired pathway. There are two boundary edges per air gap unless the air gap does not fully delineate the core along exactly two axes.

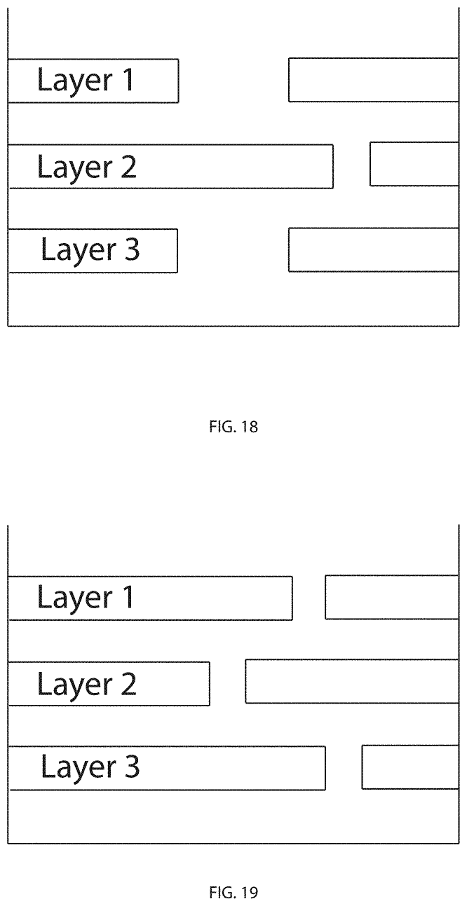

In multi-layer cores, each layer may have a separate gap. The fringing from the air gaps of each layer may interfere. Therefore, the gaps of each layer can be offset to avoid interfering with fringing, and an example of this is shown in FIG. 18.

An air gap may have larger gaps in the upper and lower layers with a smaller gap in the middle layer, as shown in FIG. 19.

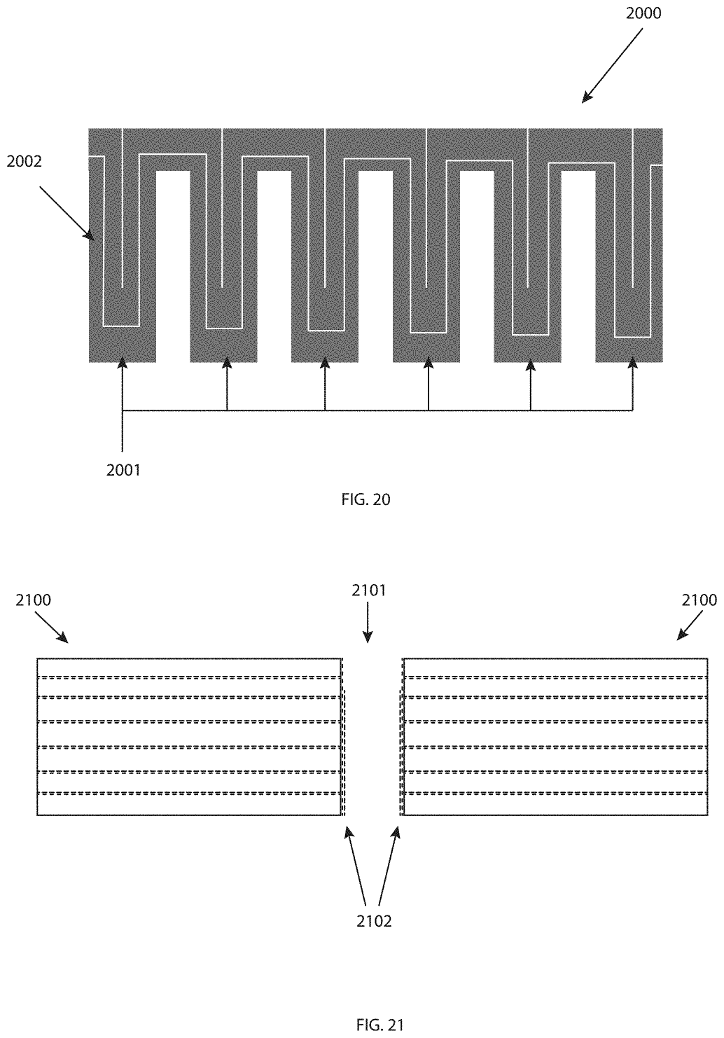

Laminated cores may come in a variety of shapes above the general torrid and solenoid distinctions, including a variety of surface patterns and rough textures such as repeating surface pillars. Creating laminated cores by lithography gives laminated cores the ability to be created in many patterns and styles and allows air gaps to be built into laminated cores in many shapes and patterns. In the present invention, an air gap may follow a laminated core according to its pattern and not just through its pattern. Therefore, a core having a rough surface pattern caused by a series of repeating connected pillars may have an air core, as demonstrated by FIG. 20 The pillars 2001 repeats, and for an air gap to follow such laminated pillars, the air gap 2002 must follow the pillar contours to some degree, because the air gap is bound to the dimensions of the core 2000. These textured laminated cores may increase pathway complexity, but the complex air gaps provide the laminated core the ability to handle even higher frequency currents than otherwise. FIG. 20 demonstrates an air gap in one layer of the core, however, every such layer may receive an air gap, and each layer's air gap may be offset.

In multi-layer cores created at least in part by a Chemical Combustion Vapor

Deposition process, CCVD in short, the insulative product of the combustion reaction will fall like snow onto the laminated core. As the air gaps in such cores may be incorporated as the core layers are built up, the insulator can be made to interact with the air gap and alter the properties of the air gap by providing a level of imperfect insulation in the air gap. This imperfect insulation will let a percentage of magnetic flux through depending on the perfection degree of its coverage. Such product may be added to any exposed air gap even after the laminated core is built. What is achieved by adding an insulator to an air gap is an air gap having less permeability. To add an insulator in this manner gives a further degree of control over the permeability of the air gap. However, the insulator need not be deposited in the air gap, and in such cases with CCVD core, the air gap will be as an air gap in a core insulated by other means.

FIG. 21 shows a CCVD-created core 2100 with air gap 2101. Notice that the CCVD deposited insulation material 2102 is deposited along the sides of the air gap 2101. The Air Gap is not fully blocked by the insulation 2102 given the random distribution along the sides of the air gap 2101. Although random, through the manufacturing process, more insulation will tend to be deposited along the bottom of the air gap 2101.

A non-exhaustive list of embodiments includes:
1. An electroplated magnetic core layer with air gap(s) comprising:
   a. One or more spiraling air gaps starting from one edge of the magnetic core to the other such that all magnetic flux flowing in the core during operation is forced to cross at least one air gap.
   b. One or more spiraling air gaps designed to uniformly cover as much surface area of a single magnetic thin film layer as possible up to the point where resulting inductance matches the specified minimum inductance requirement.
   c. Wherein the air gap is filled with epoxy, air, an oxide, or other insulator with a relative permeability of near 1.
   d. Wherein the spiral may wind around their central coil one or more times OR multiple spirals, each winding a fraction of a full winding or winding many times each. But in any case, the collective air gap winding is 1 or more times around their central coil to achieve a more uniform air gap distribution
2. An electroplated magnetic core layer with an air gap comprising:
   a. One or more spiraling air gaps starting from one edge of the magnetic core to the other such that all magnetic flux flowing in the core during operation is forced to cross at least one air gap.
   b. One or more spiraling air gaps designed to be wider in areas of otherwise higher magnetic flux and thinner in areas of otherwise lower magnetic flux such that the entire core has a uniform reluctance.
   c. Wherein the air gap is filled with epoxy, air, an oxide, or other insulator with a relative permeability of near 1.
   d. Wherein the spiral may wind around their central coil one or more times OR multiple spirals each winding a fraction of a full winding or winding many times each. But in any case, the collectively air gap winding is 1 or more times around their central coil to achieve a more uniform air gap distribution
3. An electroplated magnetic core layer with air gap comprising:
   a. One or more spiraling air gaps starting from one edge of the magnetic core to the other such that all magnetic flux flowing in the core during operation is forced to cross at least one air gap.
   b. One or more spiraling air gaps designed to be thinner near the center of the inductor core and thicker near the surfaces to compensate for greater thermal retention within the geometric center of the core, such that the resulting thermal profile is more uniform.
   c. Wherein the air gap is filled with epoxy, air, an oxide, or other insulator with a relative permeability of near 1.
   d. Wherein the spiral may wind around their central coil one or more times OR multiple spirals each winding a fraction of a full winding or winding many times each. But in any case, the collectively air gap winding is 1 or more times around their central coil to achieve a more uniform air gap distribution.
4. A spiraling air gap of embodiment 1, 2, or 3 that is approximated with a piecewise linear air gap on one or more layers.
5. A magnetic core with air gap of embodiment 1, 2, or 3, wherein the spiraling air gap is not circular but winds uniformly around a square, rectangular, or any other shape opening created by coils.
6. A multiple layer magnetic core with each layer of embodiment 1, 2, 3, or 5.
7. A multiple layer magnetic core with each layer of embodiment 1, 2, 3, or 5 is offset by a set percentage or degree such that all air gaps including those of adjacent layers distributed in such a manner as to achieve a more uniform thermal profile in three dimensions throughout the core.
8. A magnetic core of embodiment 1, 2, 3, 5, 6, or 7 wherein the magnetic layer is flat for simplicity or conversely is textured to increase surface area and in the process, increase the amount of magnetic material within the core.
9. A magnetic core of embodiment 1, 2, 3, 5, 6, 7 or 8 wherein the magnetic layer is created by electroplated magnetic material impregnated with a finely layered insulator deposited by a CCVD “Combustion Chemical Vapor Deposition” process.
10. A magnetic core of embodiment 1, 2, 3, 5, 6, 7, 8, or 9 wherein the magnetic layers are more evenly deposited through the use of levelling agents, removal of sharp corners, pulse plating, or reverse pulse plating.
11. A magnetic core of embodiment 1, 2, 3, 5, 6, 7, 8 wherein the magnetic material is NiFe 45/55, NiFe 78/22, NiFe 80/20 or other alloys of the magnetic elements of Ni, Fe, Co.
12. A magnetic core of embodiment 1, 2, 3, 5, 6, 7, 8 wherein the magnetic material is electrodeposited on to a silicon wafer or an epoxy substrate layer or film used in packaging semiconductor ICs.
13. A magnetic core of embodiment 1, 2, 3, 5, 6, 7, 8 wherein the end product is a standalone inductor or transformer.
14. A magnetic core of embodiment 1, 2, 3, 5, 6, 7, 8 wherein the end product is constructed on the surface of a silicon wafer or is constructed within a multi-layer semiconductor epoxy-based substrate for integration with a bumped integrated circuit “IC”.
15. A multi-layered magnetic core with layers of claim 1, 2, 3 where the air gap or air gaps spacing within each layer is less than the natural air gap formed between adjacent layers.

The drawings and figures show multiple embodiments and are intended to be descriptive of particular embodiments but not limited with regard to the scope or number, or style of the embodiments of the invention. The invention may incorporate a myriad of styles and particular embodiments. All figures are prototypes and rough drawings: the final products may be more refined by one skill in the art. Nothing should be construed as critical or essential unless explicitly described as such. Also, the articles “a” and “an” may be understood as “one or more.” Where only one item is intended, the term “one” or other similar language is used. Also, the terms “has,” “have,” “having,” or the like are intended to be open-ended terms. When optimization is used in the application, unless specifically denoted, it includes a partial optimization or that which has moved towards optimization from any potential prior art on the principles as described in the application.

1. A magnetic core with at least one air gap, comprising:
At least one magnetic core layer;
at least one spiraling air gap starting from an outer edge of a magnetic core layer and winding through the magnetic core to an inner edge of the magnetic core layer such that all magnetic flux flowing in the core during operation is forced to cross at least one spiraling air gap;
at least one spiraling air gap uniformly covering as much surface area of a single magnetic layer as possible up to the point where a resulting inductance matches a specified minimum inductance requirement; and
Wherein the collective winding of the spiraling air gaps is 1 or more times around an associated central coil, and the air gaps are filled with at least one or more of: an epoxy, a volume of air, an oxide, or another insulator with a relative permeability of near 1.

2. The magnetic core with at least one air gap of claim 1, wherein: at least one of the spiraling air gaps is wider through any layered magnetic core areas which otherwise would receive a higher magnetic flux and is thinner in areas which would otherwise receive a lower magnetic flux such that the entire core has a uniform reluctance.

3. The magnetic core with at least one air gap of claim 1, wherein: at least one of the spiraling air gaps is thinner near a center of the inductor core and thicker near any magnetic core surfaces such that a resulting magnetic core layer thermal profile is more uniform.

4. The magnetic core with at least one air gap of claim 1, wherein there are at least two magnetic core layers having at least one spiral air gap wherein the spiral air gaps of each magnetic core layer are offset by a set percentage or degree, given the shape of the magnetic core, from the other air gaps, such that all the air gaps, including those of adjacent layers, are distributed in a manner as to achieve a uniform thermal profile in three dimensions throughout the magnetic core.

5. The magnetic core with at least one air gap of claim 1, wherein the magnetic layer is a textured magnetic core layer.

6. The magnetic core with at least one air gap of claim 1, wherein the magnetic layers are more evenly deposited through the use of levelling agents, removal of sharp corners, pulse plating, or reverse pulse plating.

7. The magnetic core with at least one air gap of claim 1, wherein the spiraling air gap spirals around a magnetic core which has a square, a rectangular, or any other shape opening created by coils according to the pattern of the magnetic core designed to fit the coils.

8. The magnetic core with at least one air gap of claim 1, further comprising the magnetic core operationally integrated into a standalone inductor or transformer.

9. The magnetic core with at least one air gap of claim 1, further comprising the magnetic core operationally connected to the surface of a silicon wafer or operationally integrated within a multi-layer semiconductor epoxy-based substrate capable of integration with a bumped integrated circuit “IC.”

10. A magnetic core of claim 1, wherein the magnetic core layers are made of at least one of: a NiFe 45/55 alloy, a NiFe 78/22 alloy, a NiFe 80/20 alloy or another alloy of the magnetic elements of Ni, Fe, Co.

11. The magnetic core with at least one air gap of claim 10, further comprising the magnetic core layers impregnated with a finely layered “Combustion Chemical Vapor Deposition” insulator.

12. The magnetic core with at least one air gap of claim 1, wherein the air gap spacing within each layer is less than the natural air gap space formed between adjacent layers.

13. A method of producing a magnetic core with at least one air gap, comprising:
Patterning one magnetic core layer with an air gap, wherein;
the pattern includes a pattern for at least one spiraling air gap starting from an outer edge of a magnetic core layer and winding through the magnetic core to an inner edge of the magnetic core layer such that all magnetic flux flowing in the core during operation is forced to cross at least one spiraling air gap;
at least one spiraling air gap uniformly covering as much surface area of a single magnetic layer as possible up to the point where a resulting inductance matches a specified minimum inductance requirement; and
wherein the collective winding of the spiraling air gaps is 1 or more times around an associated central coil, and the air gaps are filled with at least one or more of: an epoxy, a volume of air, an oxide, or another insulator with a relative permeability of near 1;
Plating the magnetic core layer according to the pattern of the magnetic core layer with an air gap; and
Repeating the patterning of at least one magnetic core layer with an air gap,
upon a previously plated magnetic core layer, and plating a subsequent magnetic core layer according to the newly patterned layer until a desired number of magnetic core layers with air gaps is reached.

14. The method of producing a magnetic core with at least one air gap of claim 11, wherein: at least one of the spiraling air gaps is patterned to be wider through any layered magnetic core areas which otherwise would receive a higher magnetic flux and is thinner in areas which would otherwise receive a lower magnetic flux such that the entire core has a uniform reluctance.

15. The method of producing a magnetic core with at least one air gap of claim 11, wherein: at least one of the spiraling air gaps is patterned to be thinner near a center of the inductor core and thicker near any magnetic core surfaces such that a resulting magnetic core layer thermal profile is more uniform.

16. The method of producing a magnetic core with at least one air gap of claim 11, wherein there are at least two magnetic core layers having at least one spiral air gap patterned and plated wherein the spiral air gaps of each magnetic core layer are offset by a set percentage or degree, given the shape of the magnetic core, from the other air gaps, such that all the air gaps, including those of adjacent layers, are distributed in a manner as to achieve a uniform thermal profile in three dimensions throughout the magnetic core.

17. The method of producing a magnetic core with at least one air gap of claim 11, wherein the magnetic layer patterned is a textured magnetic core layer.

18. The method of producing a magnetic core with at least one air gap of claim 11, further comprising the magnetic layers being plated with the use of levelling agents, pulse plating, or reverse pulse plating—removing sharp angles.

19. The method of producing a magnetic core with at least one air gap of claim 11, wherein the pattern for at least one spiraling air gap spirals around a magnetic core which has a square, a rectangular, or any other shape opening created by coils according to the pattern of the magnetic core designed to fit the coils.

20. The method of producing a magnetic core with at least one air gap of claim 11, further comprising operationally integrating the magnetic core with at least one air gap into a standalone inductor or transformer.

21. The method of producing a magnetic core with at least one air gap of claim 11, further comprising patterning an initial magnetic core layer with air gap unto the surface of a silicon wafer or operationally integrating the magnetic core within a multi-layer semiconductor epoxy-based substrate capable of integration with a bumped integrated circuit “IC.”

22. The method of producing a magnetic core with at least one air gap of claim 11, wherein the magnetic core layers are plated of at least one of: a NiFe 45/55 alloy, a NiFe 78/22 alloy, a NiFe 80/20 alloy or another alloy of the magnetic elements of Ni, Fe, Co.

23. The method of producing a magnetic core with at least one air gap of claim 21, further comprising, utilizing a “Combustion Chemical Vapor Deposition” process to impregnate each magnetic core layer with a finely layered “Combustion Chemical Vapor Deposition” insulator.

24. The method of producing a magnetic core with at least one air gap of claim 12, wherein a pattern for the magnetic core layer with air gap is patterned so that the spacing of the air gap within each layer is less than the natural air gap space formed between adjacent layers.
